(19) United States
(12) Patent Application Publication
(10) Pub. No.: US 2005/0265033 A1
(43) Pub. Date: Dec. 1, 2005

(54) Light device for attaching to various tools

(76) Inventor: A Mei Yang, Dali City (TW)

Correspondence Address: CHARLES E. BAXLEY, ESQ., 90 JOHN STREET, THIRD FLOOR, NEW YORK, NY, 10038, US

(21) Appl. No.: 10/854,092

(22) Filed: May 25, 2004

(51) Int. Cl. F21V 21/06; F21V 21/00; F21V 21/08; F21V 21/096

(52) U.S. Cl. 362/398

(57) ABSTRACT

A light device for attaching to tool members, includes a base, a light device pivotally coupled to the base, and a magnetically attaching device for magnetically attaching the base to the tool members. The base has one or more bars to receive the magnetically attaching device. A coupler may be pivotally coupled between the base and the light device. The base has a spherical member disposed on a stud, and pivotally attached to the coupler. A ring is attached to the light device, and has a spherical member disposed on a pin, to pivotally attach to the coupler. The coupler has two plates to rotatably receive the spherical members of the base and of the ring.

### BACKGROUND OF THE INVENTION

1. Field of the Invention

The present invention relates to a light device, and more particularly to a light device for attaching to various tools, and adjustable to various angular directions.

2. Description of the Prior Art

Typically, while working in dark environment, an additional light device is required to be provided and carried with the users, to light the dark environment, and to allow the users to drive fasteners or the like in the dark environment. However, the users have to use one of their hands to carry or hold the additional light device, and to use their other hands to drive the fasteners with wrenches or screw drivers.

For allowing the users to easily drive the fasteners with wrenches or screw drivers, various kinds of typical tools have been developed and comprise a light device attached to the tools, for lighting the dark environment.

For example, U.S. Pat. No. 5,899,554 to Hsu, and U.S. Pat. No. 6,116,746 to Hsu disclose two of the typical wrench tools having a light device attached and engaged within the tool handles, to selectively light the dark environment. However, the light devices are good for the particular tools only, but may not be attached to the other tools.

U.S. Pat. No. 6,106,133 to Lee discloses another typical wrench tool having a light device selectively or detachably attached thereto. Similarly, the light device is also attached and engaged within the tool handles, and is good for the particular tools only, but may not be attached to the other tools.

The present invention has arisen to mitigate and/or obviate the afore-described disadvantages of the conventional light devices for tools.

### SUMMARY OF THE INVENTION

The primary objective of the present invention is to provide a light device for easily and readily attaching to various tools with magnetic materials.

The other objective of the present invention is to provide a light device for easily adjusting to various angular directions.

The further objective of the present invention is to provide a light device for easily clamping or attaching to various tools.

In accordance with one aspect of the invention, there is provided a light device for attaching to tool members, the light device comprising a base, a light device pivotally coupled to the base, and a magnetically attaching device for magnetically attaching the base to the tool members.

The base includes at least one bar coupled thereto, and the magnetically attaching device includes at least one magnetic member attached to the bar. The base includes a space formed therein and defined between two flaps, the bar includes a protuberance extended therefrom, and engaged into the space of the base, and a shaft engaged through the flaps and the protuberance of the bar, to pivotally attach the bar to the base.

The bar includes at least one aperture formed therein to receive the magnetic member. The base includes a lid engaged into the aperture thereof, to retain the magnetic member within the aperture of the bar. For example, the base may include two bars coupled thereto, and each having a groove formed therein, for attaching the bars and the base to the tool members.

A coupler may further be provided and pivotally coupled between the base and the light device. The base includes a stud extended therefrom, and pivotally attached to the coupler. The base includes a spherical member provided on the stud, and pivotally attached to the coupler.

The coupler includes two plates each having a recess formed therein, to rotatably receive the spherical member of the base, and to rotatably couple the base to the coupler. The coupler includes a fastener coupling the plates together, to retain the spherical member of the base between the plates of the coupler.

A ring may further be provided and attached to the light device, and pivotally coupled to the coupler, to pivotally couple the light device to the base. The ring includes a pin extended therefrom, and pivotally attached to the coupler. The ring includes a spherical member provided on the pin, and pivotally attached to the coupler.

The coupler includes two plates each having a depression formed therein, to rotatably receive the spherical member of the ring, and to rotatably couple the ring to the coupler. The light device includes a receptacle attached to the ring. The receptacle of the light device includes two housing members secured together, and the ring is secured between the housing members.

A first of the housing members includes an annular recess formed therein, to receive the ring, and to secure the ring to the housing members, and to attach the light device to the ring. The light device includes a socket and at least one battery received in the receptacle, a light member having two prongs attached to the socket, and a switch coupled between the light member and the battery, to control the light member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a light device in accordance with the present invention;

FIG. 2 is a perspective view of the light device;

FIG. 3 is a partial cross sectional view of the light device, taken along lines 3-3 of FIG. 2;

FIG. 4 is a plan schematic view illustrating the operation or the attachment of the light device onto a tool member;

FIG. 5 is a plan schematic view similar to FIG. 4, illustrating the operation or the attachment of the light device onto another tool member;

FIG. 6 is a top plan schematic view illustrating the operation of the light device; and

FIGS. 7, 8, 9, 10, 11, 12, 13, 14, 15, 16, 17 are plan schematic views illustrating the operation of the light device.

### DETAILED DESCRIPTION OF THE PREFERRED EMBODIMENT

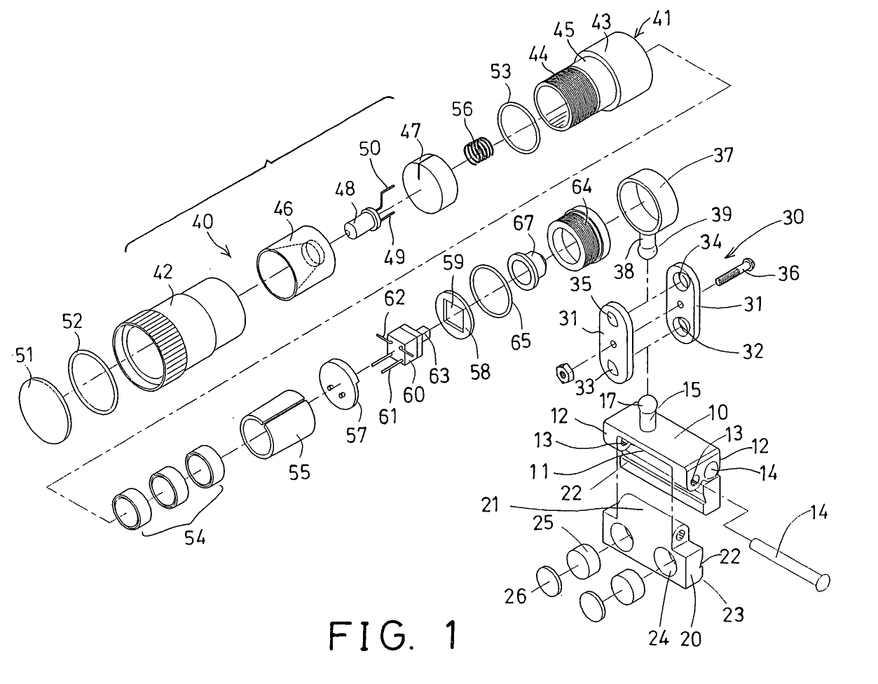

Referring to the drawings, and initially to FIGS. 1-3, a light device in accordance with the present invention comprises a base 10 including a space 11 formed therein, and preferably facing downwardly, and defined between two flaps 12. Each of the flaps 12 includes one or more, such as two orifices 13 formed therein, for receiving shafts 14 which are extended through the space 11 of the base 10.

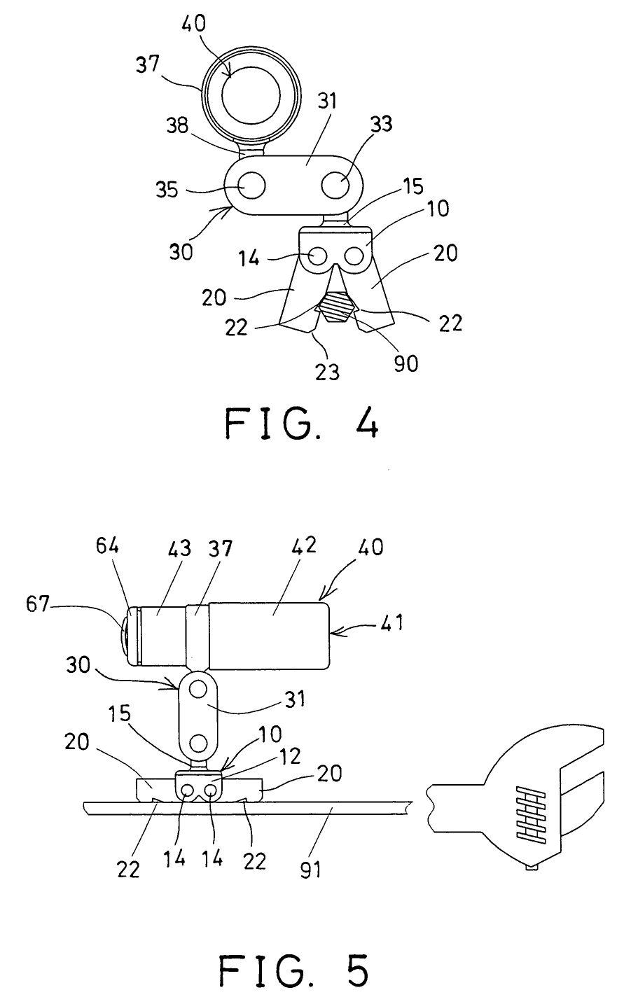

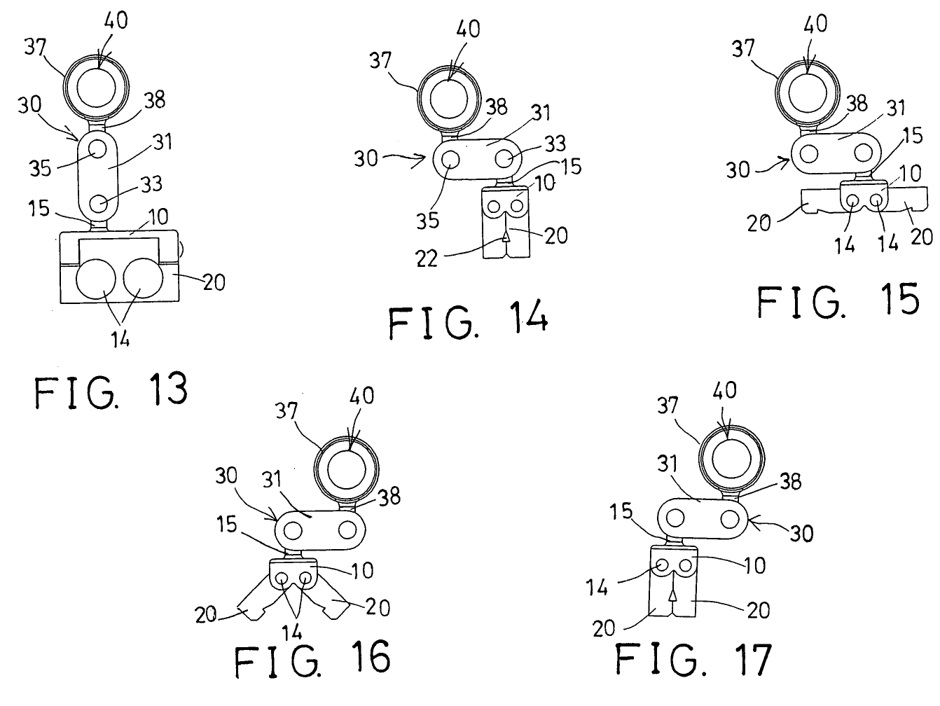

One or more, such as two bars 20, each includes a protuberance 21 extended therefrom, and engageable into the space 11 of the base 10, and pivotally attached or coupled to the shafts 14 respectively, to pivotally or rotatably attach or couple the bars 20 to the base 10 with the shafts 14 respectively, and to allow the bars 20 to be rotated relative to the base 10 (FIGS. 4-5 and 7-17).

Each of the bars 20 includes a wedge-shaped groove 22 formed therein, for engaging with tool members 90 (FIG. 4), and for stably attaching the bars 20 and thus the base 10 to the tool members 90 that have angular portions. It is preferable that each of the bars 20 includes a chamfered surface or rounded corner area 23 formed therein.

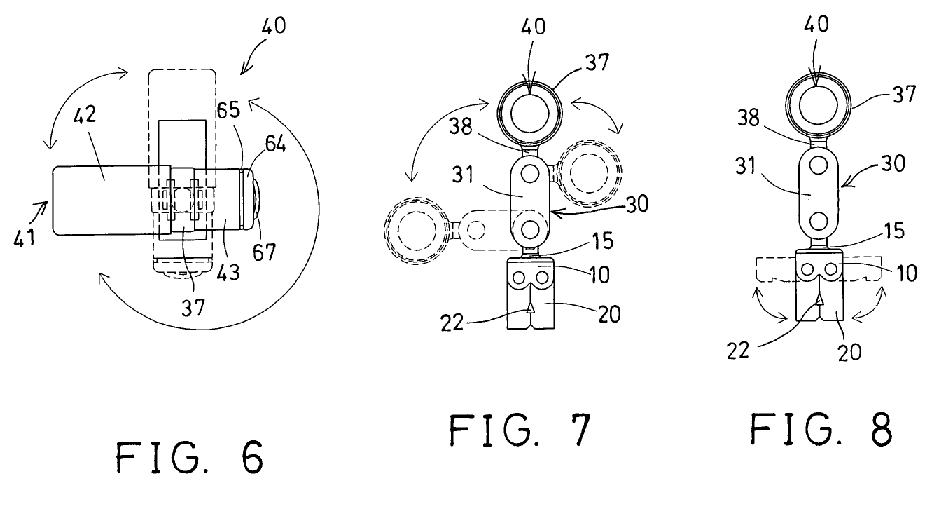

Each of the bars 20 further includes one or more apertures 24 formed therein, for receiving magnetic members 25 therein, and a lid 26 engaged into the respective aperture 24, to retain the magnetic members 25 within the respective apertures 24 of the bars 20. The magnetic members 25 may magnetically attract and secure or attach the bars 20 and thus the base 10 to the other tool members 91 (FIG. 5).

The base 10 includes a stud 15 extended therefrom, and having a ball or spherical member 17 formed or provided on top or on the free end thereof, for pivotally or rotatably attaching to a coupler 30. The coupler 30 includes two plates 31 each having a recess 32 formed in one end thereof, and defined by a bulge 33, to rotatably receive the ball or spherical member 17 of the base 10, and thus to rotatably couple the base 10 to the coupler 30.

The plates 31 may be coupled together with one or more fasteners 36, to stably retain or secure the ball or spherical member 17 of the base 10 between the plates 31 of the coupler 30. Each of the plates 31 further includes a depression 34 formed in the other end thereof, and defined by a swelling 35, for rotatably coupling to a light device 40.

The coupler 30 further includes a loop or a ring 37 having a pin 38 extended therefrom, and having a ball or spherical member 38 formed or provided on bottom or on the free end thereof, for pivotally or rotatably attaching to the coupler 30. The ball or spherical member 38 of the ring 37 may be rotatably received in the depressions 34 of the plates 31, to rotatably couple the ring 37 to the plates 31 of the coupler 30.

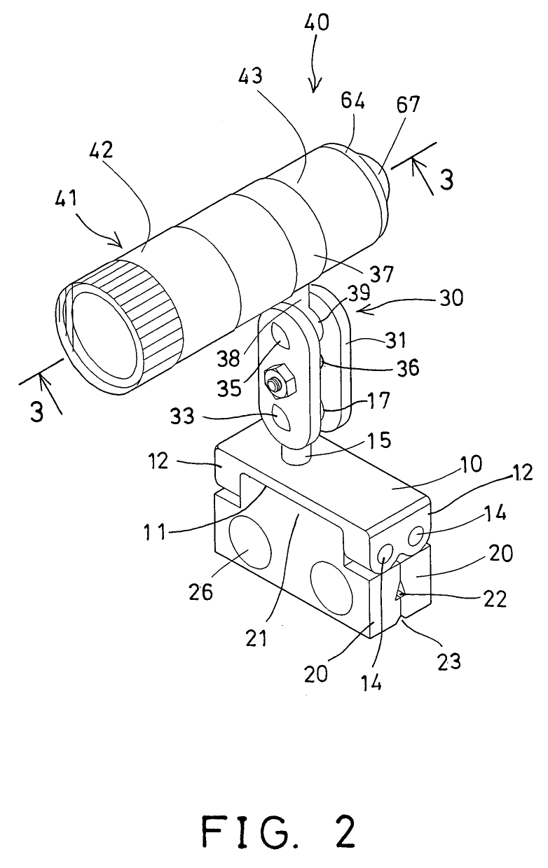

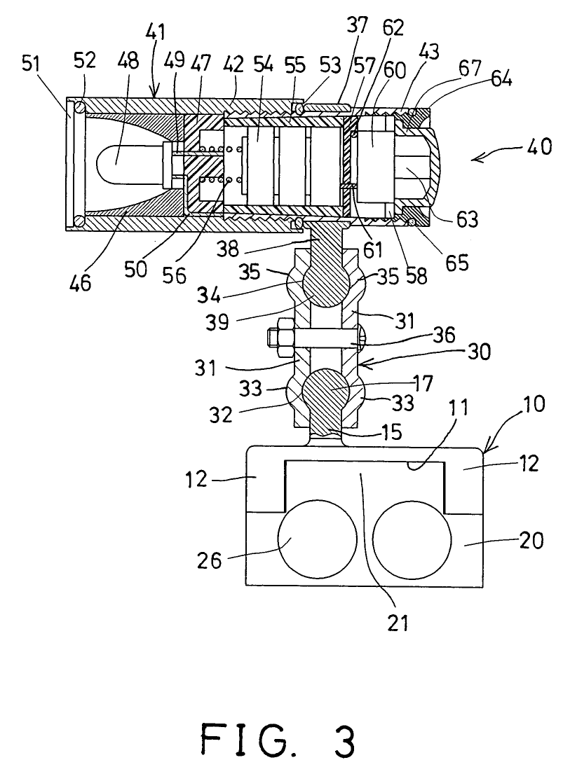

As also shown in FIGS. 1-3, the light device 40 may be attached to the coupler 30 with the ring 37, and includes a receptacle 41 having two housing members 42, 43 engageable or securable with threaded engagements 44. For example, one of the housing members 42, 43 includes an annular recess 45 (FIG. 1) formed therein, to receive the ring 37, and thus to secure the ring 37 between the housing members 42, 43, in order to stably attach or secure the light device 40 to the ring 37 (FIGS. 2, 3).

The light device 40 includes a reflector 46 and a socket 47 engaged in the front housing member 42, and a light bulb or light member 48 having two prongs 49, 50 attached or plugged to the socket 47. The light member 48 is engaged in reflector 46, to generate light, and to allow the light to be reflected and emitted out of the receptacle 41 by the reflector 46.

A cap or a lens 51 may be attached to the front portion of the front housing member 42, to enclose the front housing member 42, and to retain or to protect the light bulb or light member 48 within the front housing member 42 of the receptacle 41. A sealing ring 52 is preferably provided and engaged between the lens 51 and the front housing member 42 of the receptacle 41, to make a water tight seal between the lens 51 and the front housing member 42, and to prevent the light member 48 from being damaged by water or wetted materials.

Another sealing ring 53 may further be provided and engaged between the housing members 42, 43 of the receptacle 41, to make a water tight seal between the housing members 42, 43 and to prevent water from entering into the housing members 42, 43 of the receptacle 41.

One or more batteries 54 are received in the receptacle 41, and preferably received within a protective or non-conductive casing 55. A spring 56 is disposed between the socket 47 and the batteries 54, and electrically coupled to one of the prongs 49 of the light member 48, and electrically coupled to such as the center electrode of the batteries 54 (FIG. 3), to electrically couple the light member 48 to the batteries 54.

A board 57 and a panel 58 are received or engaged in the rear housing member 43, and the panel 58 includes a non-circular opening 59 formed therein, to receive a switch 60 therein, and to position and support the switch 60 within the rear housing member 43 of the receptacle 41.

The switch 60 includes one or more terminals 61 extended through the board 57, and electrically coupled to such as the case electrode of the batteries 54 (FIG. 3), and includes one or more further terminals 62 laterally extended and electrically coupled to the other prong 50 of the light member 48 via the housing members 42, 43 of the receptacle 41 (FIG. 3), to electrically couple the switch 60 between the batteries 54 and the light member 48.

The switch 60 includes a button 63 extended outwardly therefrom. A cap 64 may be secured to the rear housing member 43 with such as threaded engagements, to stably retain the board 57 and the panel 58 and thus the switch 60 within the rear housing member 43 of the receptacle 41. A sealing ring 65 may be provided and engaged between the housing member 43 and the cap 64, to make a water tight seal between the housing member 43 and the cap 64, and to prevent water from entering into the housing member 43 via the cap 64.

A rubber or resilient envelope or sleeve 67 may further be provided and attached to the cap 64 or to the panel 58, and engaged onto the button 63 of the switch 60, to shield and protect the button 63 of the switch 60, and to prevent water from entering into the housing member 43 and the cap 64, and to prevent the switch 60 from being damaged by water or wetted materials.

In operation, the switch 60 may be depressed or actuated by users to control the light member 48 to emit lights. The light device 40 may be attached to the base 10 with the coupler 30, and the base 10 may be attached to various tool members 90, 91 with the grooves 22 of the bars 20 (FIG. 4), and/or with the magnetic members 25 (FIG. 5), to allow the light device 40 to be attached to various tool members 90, 91.

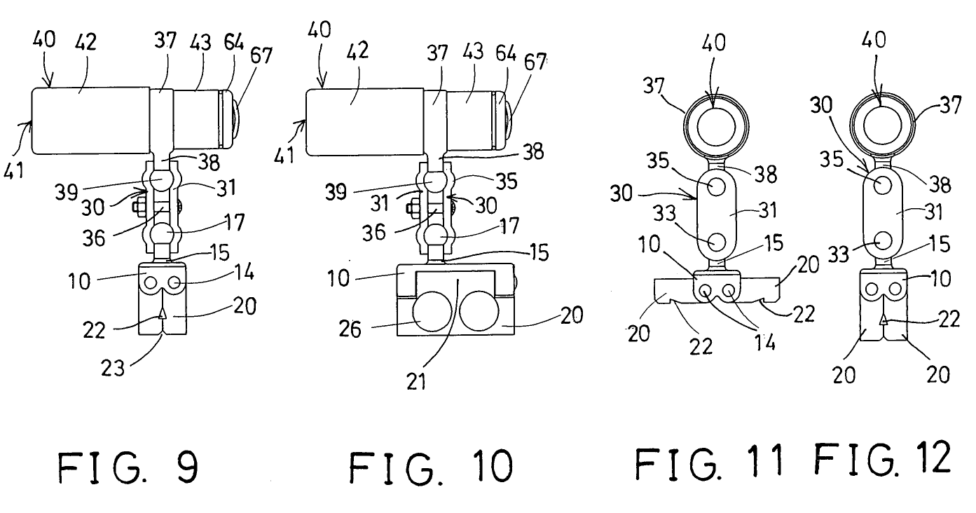

In addition, as shown in FIGS. 2-17, the light device 40 may be freely rotated relative to the coupler 30 for three hundred and sixty (360) degrees, and the coupler 30 may be freely rotated relative to the base 10 for three hundred and sixty (360) degrees, such that the light device 40 may be freely rotated relative to the base 10 to suitable or selected angular positions, and to suitably light the dark working environment.

Accordingly, the light device in accordance with the present invention may be used for easily and readily attaching to various tools with magnetic materials, or for easily clamping or attaching to various tools, and for easily adjusting to various angular directions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A light device for attaching to tool members, said light device comprising:
a base,
a light device pivotally coupled to said base, and
means for magnetically attaching said base to the tool members.

2. The light device as claimed in claim 1, wherein said base includes at least one bar coupled thereto, and said magnetically attaching means includes at least one magnetic member attached to said at least one bar.

3. The light device as claimed in claim 2, wherein said base includes a space formed therein and defined between two flaps, said at least one bar includes a protuberance extended therefrom, and engaged into said space of said base, and a shaft engaged through said flaps and said protuberance of said at least one bar, to pivotally attach said at least one bar to said base.

4. The light device as claimed in claim 2, wherein said at least one bar includes at least one aperture formed therein to receive said at least one magnetic member.

5. The light device as claimed in claim 4, wherein said base includes a lid engaged into said at least one aperture thereof, to retain said at least one magnetic member within said at least one aperture of said at least one bar.

6. The light device as claimed in claim 1, wherein said base includes two bars coupled thereto, and each having a groove formed therein, for attaching said bars and said base to the tool members.

7. The light device as claimed in claim 1 further comprising a coupler pivotally coupled between said base and said light device.

8. The light device as claimed in claim 7, wherein said base includes a stud extended therefrom, and pivotally attached to said coupler.

9. The light device as claimed in claim 8, wherein said base includes a spherical member provided on said stud, and pivotally attached to said coupler.

10. The light device as claimed in claim 9, wherein said coupler includes two plates each having a recess formed therein, to rotatably receive said spherical member of said base, and to rotatably couple said base to said coupler.

11. The light device as claimed in claim 10, wherein said coupler includes a fastener coupling said plates together, to retain said spherical member of said base between said plates of said coupler.

12. The light device as claimed in claim 7 further comprising a ring attached to said light device, and pivotally coupled to said coupler, to pivotally couple said light device to said base.

13. The light device as claimed in claim 12, wherein said ring includes a pin extended therefrom, and pivotally attached to said coupler.

14. The light device as claimed in claim 13, wherein said ring includes a spherical member provided on said pin, and pivotally attached to said coupler.

15. The light device as claimed in claim 14, wherein said coupler includes two plates each having a depression formed therein, to rotatably receive said spherical member of said ring, and to rotatably couple said ring to said coupler.

16. The light device as claimed in claim 12, wherein said light device includes a receptacle attached to said ring.

17. The light device as claimed in claim 16, wherein said receptacle of said light device includes two housing members secured together, and said ring is secured between said housing members.

18. The light device as claimed in claim 17, wherein a first of said housing members includes an annular recess formed therein, to receive said ring, and to secure said ring to said housing members, and to attach said light device to said ring.

19. The light device as claimed in claim 16, wherein said light device includes a socket and at least one battery received in said receptacle, a light member having two prongs attached to said socket, and a switch coupled between said light member and said at least one battery, to control said light member.
